(19) United States
(12) Patent Application Publication
(10) Pub. No.: US 2014/0112720 A1
(43) Pub. Date: Apr. 24, 2014

(54) Process for the removal of hydrocarbons wetlands

(71) Applicant: Bill Rippetoe, Lafayette, LA (US)

(72) Inventor: Bill Rippetoe, Lafayette, LA (US)

(21) Appl. No.: 13/694,057

(22) Filed: Oct. 24, 2012

(51) Int. Cl. B09C 1/08

(52) U.S. Cl. CPC B09C 1/08
USPC 405/128.75

(57) ABSTRACT

A method of wetland remediation with contaminated soils, sands, and water wherein the decontamination process includes removing contaminated soil from the wetlands removing oversized rocks and debris and converting the remaining contaminated soil into uniformly sized particles, spraying the soil particles with an oxidizer diluted with ionized water, vigorously mixing the sprayed soil particles with its entrained oxidizer and ionized water in an auger mixer for several minutes thereby oxidizing almost all of the hydrocarbons remaining in the soil, and removing the washed and hydrocarbon-free soil particles from the auger mixer to be placed back into the wetland environment wherein the treatment water is subject to ionization by passing water thru an Ion Collider and then placing man-made floating islands with natural wetland plants and grasses for on-going phytoremediation and natural remediation.

### FIELD OF THE INVENTION

The invention and process lies in the field of remediation of contaminated soils and water that comprise wetlands and more particularly to the removal of oil spill contaminates.

### BACKGROUND OF THE INVENTION

Oil production and exploration take place in and near wetlands and as a result they are at risk of petroleum contamination due to accidental spills, leaks, or discharges.

Current remediation processes may include incineration of the oil, land farming the contaminated soil, or burial. These techniques are not viable options for remediation of a contaminated wetland due to the limited access for equipment and the ecologically sensitive nature of these environments.

In the past and at present, there are several methods for treating hydrocarbon contaminated soils and water and include incineration, bioremediation and soil washing. Incineration has high cost of transporting the soil to and from a remote incinerator.

Bioremediation has many disadvantages that include sensitivity to changes in temperature, uneven results and the extended period of time required to complete remediation.

Soil washing techniques use surfactants to float out the hydrocarbons into the wash water requiring costly continuous water treatment to extract the hydrocarbons from the aqueous phase and may have difficulty in reducing contamination to regulatory limits.

Wetlands are a national resource and a specialized remediation process must be sensitive to the biosphere and special environmental conditions present in wetlands.

Also important is the re-beautification and re-balancing of the nature of the wetlands and how the remediation process can return and even improve the appearance of our wetlands.

### SUMMARY OF THE INVENTION

The invention has three parts to the remediation process and includes the use of an Ion Collider as shown and described in U.S. Pat. No. 5,482,629 issued Jan. 9, 1996 as the first part. Water pumped through an Ion Collider ionizes the water and alters its physical characteristics.

All embodiments of invention use Ion Collier treated water so that the use of surfactants is totally eliminated thus allowing for a natural remedy to wetland remediation.

The second part of the process includes treating the soil and water contaminated with spilled or otherwise deposited hydrocarbons such as gasoline, crude oil or like products by first passing the contaminated material through a screening process.

For soil and sand taken from the bottom of the wetlands oversized rocks and debris are removed to create uniformly sized particles. The resulting particles are sprayed with an oxidizer diluted with Ion Collier treated water and then vigorously mixed in an auger mixer for several minutes with the entrained oxidizer and Ion Collider treated water.

This vigorous mixing of the soil particles, the oxidizer and the Ion Collider treated water oxidizes the hydrocarbons, leaving the washed soil with minimal hydrocarbons well below regulatory limits. Neither Ion Collider treated water, it's spraying nor the oxidizing process itself creates prohibited products. Our method is environmentally safe.

In the case of soils contaminated with crude or other heavy oils, we may increase the volume or strength of the oxidizer and/or increase the time of vigorous mixing of the soil; the oxidizer and the ionized water to produce washed soils whose hydrocarbon content are well below regulatory limits.

The treated and clean sand and soil may then be replaced back within the environment without damaging the eco system. The process may be mounted upon a boat and/or barge and may be mobile.

The third part includes a natural phytoremediation process. The phytoremediation process is well known for correcting heavy metal contamination and the remediation of radioactivity.

Phytoremediation is also well known for hydrocarbon contamination and is cost effective as a moderate to low cost solution for remediation. Phytoremediation can be as low as 20% of mechanical cost.

Phyto-stimulation is the use of plants to speed up biodegradation by indigenous micro-degradation. Phytoremediation can also be used to speed up natural attenuation while improving the beautification astatically pleasing ground foliage

Phytoremediation can be put in place while tractability studies select permanent remedial approach. Phytoremediation can be started before other remediation processes are in place and may also remain long after remediation as part of the eco system.

The in-situ approach of phytoremediation will avoid over the road liabilities and will cut down on greenhouse gases (GHG). This can be a permanent treatment solution, mineralizing organics

The foregoing and other objectives, features, and advantages of the invention will be more readily understood upon the consideration of the following detailed description of the invention.

### BRIEF DESCRIPTION OF THE DRAWINGS

FIG. 1 is a cross-sectional plan view taken through the center of a Ion Collider;

FIG. 2 is a cross-sectional elevational view taken along line 2-2 of FIG. 1;

FIG. 3 is a cross-sectional elevational view taken along line 3-3 of FIG. 1.

FIG. 4 is a flow diagram of a preferred embodiment of our invention for treating bottom soils and sand contaminated with various types of hydrocarbons.

FIG. 5 illustrates the equipment used to treat wetlands contaminated with spilled hydrocarbons.

FIG. 6 Bio Remediation Island

### DETAILED DESCRIPTION OF THE PREFERRED EMBODIMENT

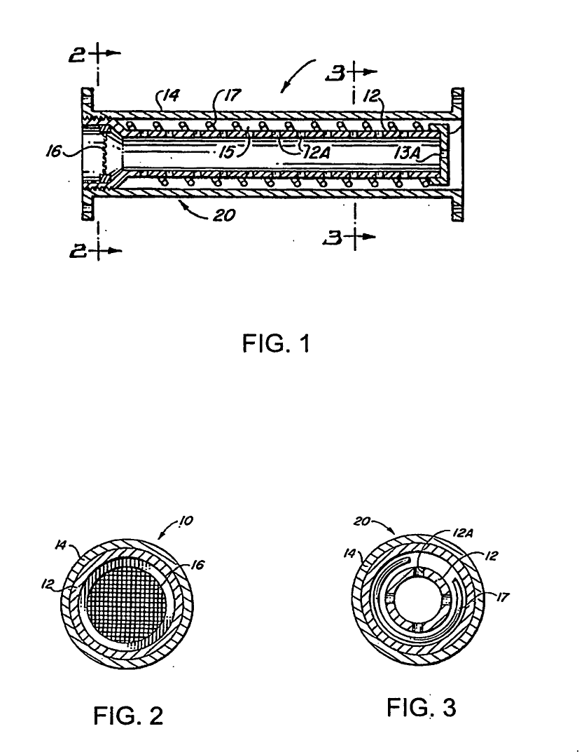

Referring to FIGS. 1 and 3, Ion Collider 10 represents the first part of the invention process and includes two spaced apart concentric elongated cylindrical metal pipes. Each pipe may be made of copper-nickel alloy or, preferably, the outer pipe 14 is made of a ferrous metal with the inner surface of the outer pipe flame coated with an alloy preferably containing 90 percent copper and 10 percent nickel.

The wall of inner pipe 12 contains a multiplicity of spaced apart radially bored holes 12A and its exit end is closed by a cap 13 which may or may not include a single hole 13A in the center of the cap. The entry end of pipe 12 is joined to outer pipe 14 as shown in FIG. 1 and a filter screen 16 of copper mesh shown in FIGS. 1 and 2 is fitted over the entry end of pipe 12 to prevent intrusion of unwanted solid particles into Ion Collider 10.

When the diameter of outer pipe 14 is four inches (10.16 cm) or greater, the inner surface of outer pipe 14 is preferably spaced about one and one-half inches (4.31 cm) from the outer surface of inner pipe 12. Both pipes 12 and 14 may be made of copper-nickel alloy in which the nickel comprises at least one percent and copper comprises at least 80 percent of the composition of the pipes. Preferably, pipe 14 is made of black iron and the inner surface of pipe 14 is flame coated with a copper-nickel alloy containing about 10 percent nickel and 90 percent copper.

For best results the sum of the cross-sectional areas of the multiplicity of holes 12A should equal or, preferably, be 1.2 times the cross-sectional area of inner pipe 12 in order to prevent any back pressure or flow restriction during operation of the Ion Collider. Moreover, the jet velocity, that is, the velocity of the liquid or gas jets as they exit from holes 12A, should be at least 0.025 feet (0.0076 m) per second. The formula for computing the jet velocity in feet (m) per second of the liquid or gas existing from holes 12A is 4,085 times the gallons (3.785 liters) per minute divided by the square of the diameter of holes 12A.

The Ion Collider has been successfully operated in various sizes. When the diameter of outer pipe 14 ranges from four to 14 inches (10.16 cm to 35.56 cm), the distance between the outer surface of the inner pipe and the inner surface of the outer pipe should be about one and one-half inches (4.31 cm), thereby creating an elongated annular chamber whose surfaces consist of copper-nickel alloy such as electron exchange chamber 15 between pipes 12 and 14 as shown in FIG. 1.

Additionally coating the inner surface of pipe 14 with a copper-nickel alloy. Flame coated pipe has a roughened irregular surface, thus presenting more surface area of copper to the turbulent action of the jetted liquid or gas in chamber 15 and causing the creation of more electrons freed from the copper or copper-nickel surface.

To increase turbulence and provide more contact surface area in chamber 15, a helix of copper or copper-nickel wire 17 is loosely wrapped around the length of the outer surface of inner pipe 12.

The Ion Collider may be used to treat a wide variety of liquids and gases to produce economically beneficial changes in the physical characteristics of the liquids. Fluids treated include hydrocarbon fuels, numerous oils, crude oil storage tank “bottoms,” and water.

Water treated with a Ion Collider reduces its boiling point and, thus, the energy required to convert the water into steam. Treatment also “softens” the water, reducing or eliminating the need for water-softening chemicals, and inhibits the formation of scale and removes existing scale. Ion Collider treatment followed by filtration softens water, enhancing the remediation.

Treated water may also penetrate the bottom soil, creating an ion exchange in the soil resulting in a breakdown of salts in the soil which prevents tip burn and salt poisoning in plants and trees while at the same time enhancing the plants' ability to absorb nutrients from the soil and fertilizers.

Any nitrates and phosphates that have been introduced by fertilizers will be broken down thereby reducing the contaminating effects of run-off on stream, rivers and estuary waters.

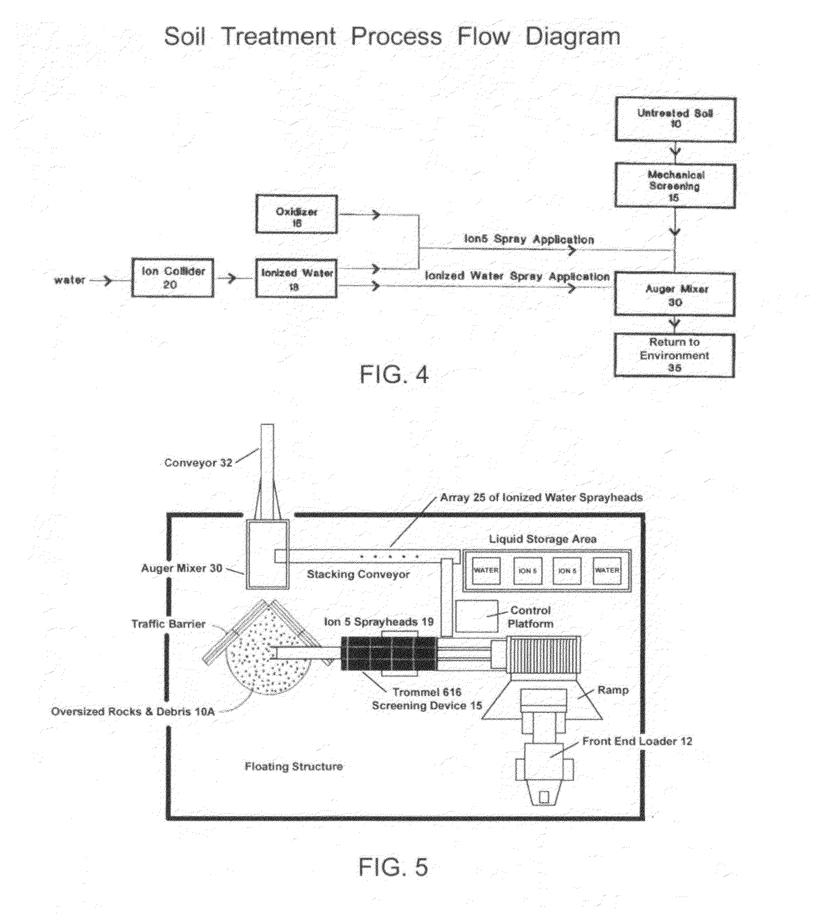

The second part may be more readily understood with the following diagram and drawing wherein FIG. 4 shows a flow diagram of a typical wetland with contaminated soil, sand and water with spilled or deposited gasoline, diesel fuel, motor oil, hydraulic fluid and other hydrocarbons.

FIG. 5. is a plan view of the equipment mounted upon a floating vessel used to carry out the method of cleaning soils shown in FIG. 4.

Contaminated and untreated soil 10 is pumped to front end loaders 12 to a mechanical screening device 15 such as a Trommel brand or like device to reduce the soil to uniformly sized particles from which oversized rocks and debris 10A are removed and discarded as shown in FIG. 5.

The soil particles resulting from the screening process are sprayed with an oxidizer 16 such as potassium permanganate diluted to a concentration of between 275 to 1000 milligrams of oxidizer to a liter of ionized water 18, that is, water which has been passed through an Ion Collider 20 and thereby electrically charged, i.e. ionized. Two spray heads 19 spraying oxidizer 16 diluted with ionized water 18 are shown in FIG. 5.

The two storage tanks marked Ion5 in the liquids storage area shown in FIG. 5 are filled with oxidizer 16 diluted with ionized water and the two storage tanks marked water contain ionized water used in our unique method of removing hydrocarbons from soils.

Following their being sprayed with an oxidizer diluted with ionized water from Ion5 spray heads 19, the soil particles as they are moved along a conveyor are sprayed with ionized water 18 from an array 25 of spray nozzles as shown in FIG. 5.

The washed sand/soil particles are then vigorously mixed for several minutes with the entrained oxidizer and ionized water in an Eagle Brand auger mixer 30 as shown in both FIGS. 4 and 5.

The process oxidizes the remaining hydrocarbons, leaving the washed soil almost totally free of hydrocarbons. The washed and hydrocarbon-free soil is fed from the auger mixer 30 along a conveyor 32.

The third and final step of the process allows for the placement of a natural phytoremediation process floating island. The phytoremediation process is well known for remediation of contamination and shall involve creating floating surfaces with live biospheres.

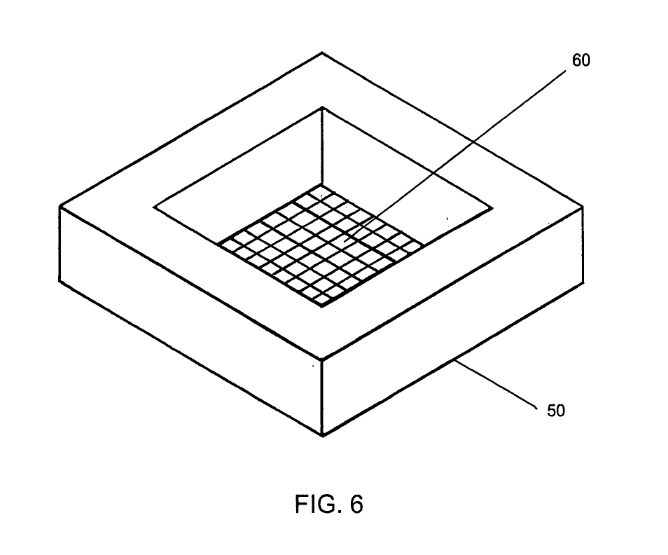

FIG. 6 details a typical configuration of a bio-island utilizing the phytoremediation process and may consist of any number of floating structures 50 with a mess or solid foam interior surface 60 for the placement of wetland plants 70.

Phytoremediation is nature's way to purify and cleanse water. The plants 70 (Not shown for clarity) offer surface area and circulation for water and air will remove pollutants from water. The floating structure 50 provide an augmented surface area that will offer on-going purification of the water.

The interior surface 60 may be comprised of a netting mat, or like material that may be planted with local wetland plants and launched onto a waterway.

The netting mat surface 60 also acts as a water filtration material and may be made from 100% recycled plastic. The island shape can be made in any suitable shape or size.

Large islands may be constructed using a modular attachment system and may reinforced for extra buoyancy. Additionally, islands may be anchored or tethered in place or may be left to float around freely.

It may be thus seen that the objects of the present invention set forth, as well as those made apparent from the forgoing description are efficiently attained. While the preferred embodiments of the invention have been set forth for purposes of disclosure, modifications of the disclosure embodiments of the invention as well as other embodiments thereof may occur to those skilled in the art accordingly.

I claim:

1. A method of removing contamination from wetlands comprising
Subjecting treatment water to ionization by passing water thru an Ion Collider;
Pulling contaminated soil, sand and water from wetlands;
removing oversized rocks and debris and converting the remaining contaminated soil into uniformly sized particles,
spraying the soil particles with an oxidizer diluted with ionized water,
vigorously mixing the sprayed soil particles with its entrained oxidizer and ionized water in an auger mixer for several minutes thereby oxidizing almost all of the hydrocarbons remaining in the soil, and
removing the washed and hydrocarbon-free soil particles from the auger mixer to be placed back into the wetland environment, and
place man-made floating islands with natural wetland plants and grasses for on-going phytoremediation and natural remediation.

2. The method of claim 1, wherein a Ion Collider is used to create ionized water for treatment of contaminated soil wherein;
treatment water is forced under pressure into an elongated cylindrical chamber, the fluid is pushed out of the elongated chamber through a plurality of holes in the wall of the chamber in the form of jets of fluid directed against the walls of an axially aligned annular chamber, the walls of said axially aligned annular chamber being made of copper-nickel alloy to induce the alloy to give up electrons, and combining the freed electrons with molecules of the fluid to thereby alter the physical characteristics of the fluid and creating an enhanced treatment water for remediation.

3. A method of removing hydrocarbons from soils contaminated with deposited hydrocarbons as set forth in claim 1 in which the soil particles are sprayed with ionized water following their being sprayed with an oxidizer diluted with ionized water but before the particles are vigorously mixed with entrained oxidizer and ionized water in an auger mixer.

4. A method of removing hydrocarbons from soils contaminated with deposited hydrocarbons as set forth in claim 1 in which the oxidizer is potassium permanganate diluted to a concentration of from 275 to 1,000 milligrams of potassium permanganate to one liter of ionized water.

5. The method of claim 2, wherein the copper-nickel alloy is flame coated onto said second elongated pipe to form said inner surface.

6. The method of claim 2, wherein a method of changing the physical characteristics of a fluid in which the sum of the cross-sectional areas of the plurality of holes in the wall of the elongated cylindrical chamber is greater than the cross-sectional area of the elongated cylindrical chamber.

7. The method of claim 2, wherein a method of changing the physical characteristics of a fluid as set forth in claim 1 in which the velocity of the jets of fluid exiting from the plurality of holes in the wall of the elongated cylindrical chamber is at least 0.025 feet (0.0076 m) per minute.

8. The method of claim 2, wherein the copper-nickel alloy is flame coated onto said second elongated pipe to form said inner surface.

9. The method of claim 2, wherein the treating apparatus includes a copper wire wound around the outside of the first pipe in the form of a helix.

10. The method of claim 2, wherein said first pipe is made of a copper-nickel alloy, and said second pipe is made of black iron, said copper-nickel surface being applied to said second pipe inner surface by flame coating.

11. The method of claim 2, wherein the sum of the cross-sectional areas of the plurality of holes in the wall of the elongated cylindrical chamber is greater than the cross-sectional area of the elongated cylindrical chamber.

12. The method of claim 2, wherein the velocity of the jets of fluid exiting from the plurality of holes is at least 0.025 feet per minute.

13. The method of claim 1 wherein multiple phytoremediation islands are connected together to create larger surface areas of remediation.

14. The method of claim 1 wherein phytoremediation islands are have a solar driven filtration means for pulling water thru filters before returning to the wetlands.

15. The method of claim 1 wherein phytoremediation islands are anchored to the bottom of the wetlands.

16. The method of claim 1 wherein phytoremediation islands are equipped with solar powered pumps attached to water spray nozzles.
